(19) United States
(12) Patent Application Publication
(10) Pub. No.: US 2023/0165242 A1
(43) Pub. Date: Jun. 1, 2023

(54) RODENTICIDAL BAIT AND METHOD OF CONTROLLING TARGET HARMFUL RODENTS

(71) Applicants: LIPHATECH, Pont-du-Casse (FR); INSTITUT ENSEIGNEMENT SUPERIEUR ET RECHERCHE EN ALIMENTATION SANTE ANIMALE SCIENCES AGRO NOMIQUES, Marcy L'ETOILE (FR)

(72) Inventors: Virginie LATTARD, TASSIN-LA-DEMI-LUNE (FR); Hervé CARUEL, MONCAUT (FR); Etienne BENOIT, TASSIN-LA-DEMI-LUNE (FR); Jean-Valéry DEBAUX, LYON (FR)

(21) Appl. No.: 17/922,953

(22) PCT Filed: Apr. 28, 2021
(86) PCT No.: PCT/FR2021/050735

§ 371 Date: Nov. 2, 2022

(30) Foreign Application Priority Data
May 5, 2020 (FR) 20 04440

(51) Int. Cl. A01N 25/00; A01N 31/06; A01N 43/16; A01N 43/18; A01P 11/00

(52) U.S. Cl. CPC A01N 25/004; A01N 31/06; A01N 43/16; A01N 43/18; A01P 11/00

(57) ABSTRACT

The invention relates to a rodenticidal bait by ingestion for at least one target harmful rodent ingesting this bait for an ingestion period, called consumption time, imposed owing to said ingestion; the rodenticidal bait comprising:
a composition, called composition of AVK(s), of at least one compound that inhibits vitamin K recycling;
a composition, called vitamin D composition, of at least one hypercalcaemia-causing vitamin D, and
at least one excipient that is edible for target harmful rodents;
   characterized in that:
said composition of AVK(s) is present in the rodenticidal bait in a proportion by weight, called proportion of AVK(s) by weight, that is not zero and is not lethal on its own for any target harmful rodent, and in that
said vitamin D composition is present in the rodenticidal bait in a proportion by weight, called the proportion of vitamin D by weight:
   sufficient for said vitamin D composition to be lethal on its own for at least one target harmful rodent, and
   below a minimum proportion by weight sufficient for said vitamin D composition to be lethal on its own for any target harmful rodent. The invention also relates to the uses of a rodenticidal bait according to the invention and a method of controlling target harmful rodents.

The invention relates to a rodenticidal bait by ingestion and a method of controlling target harmful rodents in which said rodenticidal bait is made available to target harmful rodents. The invention therefore relates to combating the uncontrolled development of populations of target harmful rodents.

Rodenticidal baits by ingestion, comprising as the active substance at least one compound that inhibits blood coagulation, are known. In particular, rodenticidal baits by ingestion are known that comprise at least one such compound that inhibits blood coagulation, called first generation anticoagulant, producing a rodenticidal effect after several successive doses of bait, such as warfarin (called coumaphène in France), chlorophacinone, diphacinone and coumatetralyl. Rodenticidal baits by ingestion are also known that comprise at least one such compound that inhibits blood coagulation, called second-generation anticoagulant, capable of producing a rodenticidal effect after a single dose of bait, such as bromadiolone, difenacoum, brodifacoum, flocoumafen and difethialone, with brodifacoum, flocoumafen and difethialone having the property of being effective on strains of target harmful rodents resistant to at least one first-generation anticoagulant and/or to bromadiolone and/or difenacoum.

These rodenticidal baits could be consumed by non-target animals, other than target harmful rodents, before or while being made available to target harmful rodents. They may be consumed directly (primary consumption) and accidentally by wild animals or domestic animals or pets or by humans—especially by children. Said consumption may produce, in these wild or domestic animals, in these pets or in humans, and especially in children, poisoning that may be lethal in the short, medium, or long term, taking into account the persistence of these anticoagulants in the organism, in particular in humans, and their anticoagulant effects in the organism.

Furthermore, taking into account the considerable persistence of these anticoagulants in the organism of the target harmful rodents, in particular in the case of second-generation anticoagulants, the anticoagulant in said rodenticidal bait may be ingested (secondary consumption) by wild or domestic animals—especially by birds—that are predators of harmful rodents that have been poisoned and weakened after consuming said rodenticidal bait or by animals that are carrion feeders of harmful rodents that have died after consuming said rodenticidal bait. This secondary consumption is likely to lead ultimately to the death of these wild or domestic animals that are predators or carrion feeders, which may be animals—especially birds—belonging to protected species.

Solutions are required for limiting the risks of said primary and/or secondary poisoning. Such solutions aim most often to decrease the doses of anticoagulants in the rodenticidal baits, often to the detriment of the efficacy of these baits.

Furthermore, the use of these rodenticidal baits has led to the emergence and selection of strains of target harmful rodents that have become resistant to many first-generation anticoagulants as well as to certain second-generation anticoagulants. In particular, the strains Y139C, Y139F and L120Q of the brown rat (Rattus norvegicus) are known that are resistant to coumatetralyl, bromadiolone and difenacoum.

Solutions for controlling the populations of strains of target harmful rodents that have become resistant to many first-generation anticoagulants and to certain second-generation anticoagulants are also required.

US2018/027813 describes a rodenticidal bait comprising coumatetralyl (375 ppm) and cholecalciferol (100 ppm). US2018/027813 describes experiments carried out in the laboratory, in which such a bait is made available to male and female adult brown rats (Rattus norvegicus) of the wild-type strain for 10 days. US2018/027813 describes that the brown rats in the experiments consume the bait ad libitum, and die owing to internal haemorrhage. US2018/027813 describes that the brown rats in the experiments stop their consumption of bait (“stop feeding effect”) after 3 days of consumption. For comparison, US2018/027813 describes that brown rats in a control group continue consuming a control rodenticidal bait containing only coumatetralyl (375 pm) as active substance for 10 days. The rodenticidal bait in US2018/027813, in which the active substance is formed from coumatetralyl (375 ppm) and cholecalciferol (100 ppm) makes it possible to maintain rodenticidal efficacy for reduced consumption of rodenticidal bait relative to a rodenticidal bait in which the active substance is formed from coumatetralyl alone.

The rodenticidal bait in US2018/027813 does not allow the amount of anticoagulant in a rodenticidal bait to be decreased and does not make it possible to limit the risks of poisoning by primary consumption. Nor does it make it possible to limit the risks of poisoning by secondary consumption.

The invention aims to overcome these drawbacks.

US2018/027813 also describes that a rodenticidal bait comprising coumatetralyl (375 ppm) and cholecalciferol (100 ppm) as active substance exhibits rodenticidal efficacy on a group of brown rats of the bromadiolone-resistant strain Y139 C consuming this bait, which is greater than the rodenticidal efficacy of a rodenticidal bait comprising coumatetralyl (375 ppm) as active substance on a comparable group of brown rats of this strain Y139 C. The rodenticidal bait in US2018/027813 comprising a proportion of active substance (coumatetralyl) that is anticoagulant does not make it possible to limit the risk of poisoning of non-target animals by primary consumption, especially accidental. Not does it make it possible to exclude completely the risk of poisoning of non-target animals by secondary consumption and their death by haemorrhage.

The invention therefore aims to overcome these drawbacks.

The invention aims in particular to propose a rodenticidal bait and a method of controlling—in particular a method of selectively controlling—target harmful rodents in which said rodenticidal bait is used that is effective for controlling the populations of target harmful rodents.

The invention also aims to propose said bait and said method that are effective for controlling the populations of target harmful rodents and also make it possible to limit the risks of secondary poisoning of wild animals—for example foxes or birds—that are predators of target harmful rodents that are weakened after consuming the rodenticidal bait or wild animals that are carrion feeders of target harmful rodents that have died through poisoning.

The invention also aims to propose such a bait and such a method whose use complies with the rules of good usage, in particular with respect to the protection of birds, and especially birds of prey.

The invention also aims to propose such a bait and such a method that do not require, for effectively controlling a population of target harmful rodents, the use of a rodenticidal active substance at a high dose and that are harmless to the environment, human health and non-target animals, especially birds.

The invention also aims to propose such a bait and such a method that are usable for controlling the populations of target harmful rodents that have become resistant to certain rodenticidal anticoagulant active substances and to baits containing said active substances.

The invention also aims to propose such a rodenticidal bait and such a method of controlling target harmful rodents, which make it possible to combat target rodents that are resistant to at least one conventional rodenticidal anticoagulant active substance.

The invention thus aims to propose such a rodenticidal bait and such a method that makes it possible to combat target rodents that are resistant to first-generation anticoagulant rodenticides, such as for example warfarin (coumaphène in French) and/or to second-generation anticoagulant rodenticides, such as for example difenacoum and bromadiolone.

For this purpose, the invention relates to a rodenticidal bait by ingestion for at least one target harmful rodent ingesting this bait for a period, called the consumption time, imposed owing to said ingestion;
the rodenticidal bait comprising:
   a composition, called composition of AVK(s), of at least one compound that inhibits vitamin K recycling;
   a composition, called vitamin D composition, of at least one hypercalcaemia-causing vitamin D, and
   at least one excipient that is edible for target harmful rodents; characterized in that:
   said composition of AVK(s) is present in the rodenticidal bait in a proportion by weight, called the proportion of AVK(s) by weight, that is not zero and is not lethal on its own for any target harmful rodent ingesting this bait for said consumption time, and in that:
   said vitamin D composition is present in the rodenticidal bait in a proportion by weight, called the proportion of vitamin D by weight:
      sufficient for said vitamin D composition to be lethal on its own for at least one target harmful rodent, and
      below a minimum proportion by weight sufficient for said vitamin D composition to be lethal on its own for any target harmful rodent.

Throughout the text, the expression “proportion by weight” of said composition of AVK(s) in the rodenticidal bait denotes the ratio of the weight of said composition of AVK(s) to the total weight of rodenticidal bait containing said composition of AVK(s). The proportion by weight of said composition of AVK(s) is necessarily non-zero, so that the rodenticidal bait necessarily contains at least one compound that inhibits vitamin K recycling. The expression “proportion by weight” of said vitamin D composition in the rodenticidal bait denotes the ratio of the weight of said vitamin D composition to the weight of rodenticidal bait containing said vitamin D composition. The expression “proportion by weight” of said composition of active substance denotes the ratio of the weight of said composition of active substance to the total weight of rodenticidal bait containing said composition of active substance, expressed in grams of composition of active substance per gram of rodenticidal bait. The expression “proportion by weight” of said composition of AVK(s) denotes the ratio of the weight of said composition of AVK(s) to the total weight of rodenticidal bait containing said composition of AVK(s), expressed in grams of composition of active substance per gram of rodenticidal bait. The expression “proportion by weight” of said vitamin D composition denotes the ratio of the weight of said vitamin D composition to the total weight of rodenticidal bait containing said vitamin D composition, expressed in grams of composition of active substance per gram of rodenticidal bait. In general, this proportion by weight is expressed in ppm (parts per million), i.e. in milligrams of composition of substance, in milligrams of composition of AVK(s) or in milligrams of vitamin D composition, per kilogram of rodenticidal bait.

Said proportion of AVK(s) is not zero and is selected to be non-lethal on its own for any target harmful rodent ingesting, for said consumption time, a bait, called bait of AVK(s), formed from said at least one excipient and said composition of AVK(s)—alone as active substance in said bait of AVK(s)—in said proportion of AVK(s). Said proportion of AVK(s) of said composition of AVK(s) is sublethal on its own, i.e. below the proportion of said composition of AVK(s) in said bait of AVK(s) required to cause death by haemorrhage of at least one target harmful rodent consuming said bait of AVK(s) for said consumption time. In a rodenticidal bait according to the invention, said composition of AVK(s) is present in a non-zero proportion of AVK(s) that is not sufficient to be anticoagulating for any target harmful rodent consuming this rodenticidal bait for said consumption time. Of course, it is not excluded that a small number and a small proportion of target harmful rodents—in particular a proportion less than or equal to 5%—die on consuming said bait of AVK(s) comprising said composition of AVK(s) alone as active substance in said bait of AVK(s) and in said proportion of AVK(s), this mortality not being caused by haemorrhage dependent on the AVK(s).

According to the invention, said proportion of AVK(s) is non-zero. However, said proportion of AVK(s) is not sufficient to be anticoagulating for any target harmful rodent ingesting this rodenticidal bait for said consumption time. In particular, it is non-lethal on its own for any target harmful rodent sensitive to warfarin (coumaphène) ingesting this rodenticidal bait for said consumption time. In particular, according to the invention, said proportion of AVK(s) is non-lethal on its own for any target harmful rodent resistant in particular to warfarin ingesting this rodenticidal bait for said consumption time.

A rodenticidal bait according to the invention makes it possible to reduce, or even eliminate, owing to reduction of the dose of rodenticidal active substance, the risks of secondary poisoning of any wild animal—for example for any fox or for any bird—that is a predator of target harmful rodents weakened after consuming the rodenticidal bait or for any wild animal that is a carrion feeder of target harmful rodents that have died through poisoning. A rodenticidal bait according to the invention is therefore safe in that it makes it possible to limit the risks of secondary poisoning of species of non-target animals that are predators of said target harmful rodents weakened or of carrion feeders of said target harmful rodents that have died through poisoning.

Said vitamin D composition is present in the rodenticidal bait in a proportion by weight, called the proportion of vitamin D by weight, which is:
sufficient for said vitamin D composition to be lethal on its own for at least one target harmful rodent consuming a bait, called vitamin-laced bait, formed from said at least one excipient and said vitamin D composition—alone as active substance in said vitamin-laced bait—in said proportion of vitamin D, and
below a minimum proportion by weight sufficient for said vitamin D composition to be lethal on its own for any target harmful rodent consuming a bait formed from said at least one excipient and said vitamin D composition—alone as active substance in this bait—in said minimum proportion by weight.

In certain embodiments, said proportion of vitamin D is adapted so that said vitamin D composition is lethal on its own for only a fraction of target harmful rodents consuming a bait not containing said composition of AVK(s) and comprising said vitamin D composition in said proportion of vitamin D, the fraction of target harmful rodents dying through consumption of this bait being less than 100%, in particular between of the order of 20% and of the order of 90%, in particular between of the order of 20% and of the order of 50%, preferably between of the order of 20% and of the order of 40%, even more preferably of the order of 30%.

Moreover, it has been found that:
said vitamin D composition has a low persistence and a short half-life—in particular of the order of 5 hours—in the tissues—in particular in the plasmatic tissues—of target harmful rodents consuming the rodenticidal bait according to the invention, and that:
at least some of the products of catabolism of the active forms of the hypercalcaemia-causing D vitamins of said vitamin D composition do not in themselves cause hypercalcaemia;
so that the risk of secondary poisoning linked to this substance is reduced or even eliminated completely.

Furthermore, since said composition of AVK(s) is present in the rodenticidal bait in a proportion of AVK(s) that is not sufficient to be anticoagulating, consumption of said rodenticidal bait by target harmful rodents does not lead to selection of target harmful rodents that are resistant to said composition of AVK(s). In fact, a mutant genotype—in the Vkorc1 gene coding for subunit 1 of the vitamin K epoxide reductase complex (“Vitamin K epOxide Reductase Complex (VKORC) subunit 1”)-capable of conferring a phenotype with resistance to at least one anticoagulant on a target harmful rodent, does not constitute a selective advantage for target harmful rodents exposed to said anticoagulant.

Completely surprisingly, a bait according to the invention containing, as active substance, a mixture of:
a composition of at least one compound that inhibits vitamin K recycling, called composition of AVK(s), in a proportion in the rodenticidal bait selected so that said composition of AVK(s) is neither anticoagulant on its own nor lethal on its own for any target harmful rodent consuming this bait for said consumption time, and
a composition, called vitamin D composition, of at least one hypercalcaemia-causing vitamin D, in a proportion in the rodenticidal bait selected so that said vitamin D composition is lethal for at least one target harmful rodent consuming this bait but is not lethal for all target harmful rodents consuming this bait;
in fact allows effective control of a population of target harmful rodents with an increased efficacy relative to the rodenticidal efficacy displayed by a rodenticidal bait comprising said vitamin D composition alone as the rodenticidal active substance, with the proportion of said vitamin D composition of a bait according to the invention.

The inventors assume, without this assumption being supported by biology or by physiology, that said composition of AVK(s) used in a rodenticidal bait according to the invention, with said proportion of AVK(s), would display a synergistic effect with said vitamin D composition, in which the increase in tissue calcium provided by said vitamin D composition would be amplified by said composition of AVK(s). The inventors have shown that target harmful rodents consuming a rodenticidal bait according to the invention do not present a significant increase in blood clotting time, but show on autopsy an increase of calcium in the tissues.

A rodenticidal bait according to the invention makes it possible to achieve a high mortality, in particular a mortality between 90% and 100%, inclusive, in target harmful rodents consuming this rodenticidal bait.

Furthermore, this synergy makes it possible to:
reduce the proportion of said vitamin D composition in the rodenticidal bait relative to the proportion of said vitamin D composition of a bait comprising said vitamin D composition alone as active substance, for an identical rodenticidal effect;
reduce correlatively the digestive toxicity provided by said vitamin D composition;
reduce the aversion effect for the rodenticidal bait (“stop feeding effect”) owing to inhibition of intestinal peristalsis by said vitamin D composition.

In certain embodiments, said proportion of vitamin D is selected to allow consumption of said rodenticidal bait by the target harmful rodents for 3 consecutive days.

The rodenticidal bait according to the invention makes it possible to control a population of target harmful rodents. In certain embodiments, the rodenticidal bait is lethal for a great majority of target harmful rodents consuming this rodenticidal bait. According to the Directives of the European Chemicals Agency (“European CHemicals Agency, ECHA”), a bait is in particular regarded as a rodenticide provided that it makes it possible to achieve a mortality of at least 90% for target rodents.

In certain embodiments, said composition of AVK(s) comprises at least one anticoagulant compound that is an inhibitor of vitamin K recycling.

In certain embodiments, said composition of AVK(s) comprises—in particular is formed exclusively from—at least one compound that inhibits vitamin K recycling selected from the group comprising 4-hydroxycoumarins substituted in position 3, 4-hydroxythiocoumarins substituted in position 3 and indan-1,3-diones substituted in position 2.

In certain embodiments, said composition of AVK(s) comprises—in particular is formed exclusively from—at least one 4-hydroxycoumarin substituted in position 3 of the following general formula (Chem.1):

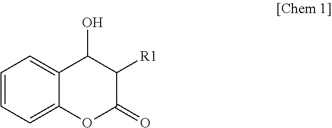

in which R1 is an organic group comprising carbon atoms, hydrogen atoms and, if applicable, at least one oxygen atom and/or at least one halogen atom—in particular a bromine atom.

In certain embodiments, said composition of AVK(s) comprises—in particular is formed exclusively from—at least one 4-hydroxythiocoumarin substituted in position 3, of the following general formula (Chem.2):

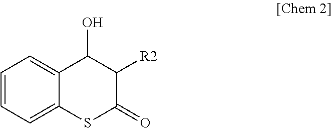

in which R2 is an organic group comprising carbon atoms, hydrogen atoms and, if applicable, at least one halogen atom—in particular a bromine atom.

In certain embodiments, said composition of AVK(s) comprises—in particular is formed exclusively from—at least one indan-1,3-dione substituted in position 2, of the following general formula (Chem.3):

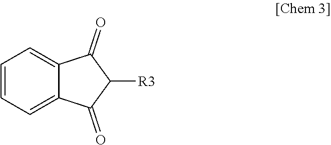

in which R3 is an organic group comprising carbon atoms, hydrogen atoms and, if applicable, at least one oxygen atom and/or at least one halogen atom—in particular a chlorine atom.

In certain embodiments, said composition of AVK(s) comprises—in particular is formed exclusively from—at least one 4-hydroxycoumarin substituted in position 3 selected from the group comprising coumachlor, warfarin, coumatetralyl, dicoumarol, acenocoumarol, phenprocoumon, 3-(1-(4′-fluorobiphenyl-4-yl)-ethyl)-4-hydroxy-2H-1-benzopyran-2-one, of formula (Chem.4) hereunder,

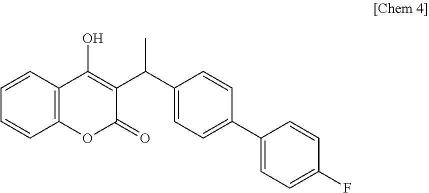 [SMILES: CC(c1ccc(-c2ccc(F)cc2)cc1)c1c(O)c2ccccc2oc1=O]

compounds of formula (Chem.5) hereunder,

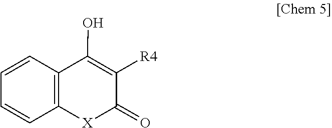

in which X is an atom selected from the group comprising oxygen (O) and sulphur (S) and R4 is a hydrocarbon-containing group selected from the group comprising a 3-phytyl group and linear hydrocarbon chains having from 8 to 18 carbon atoms;
bromadiolone, brodifacoum, flocoumafen, difenacoum and difethialone.

In certain particular embodiments, said composition of AVK(s) comprises-in particular is formed exclusively from—bromadiolone denoting the compound 3-[3-(4′-bromo[1,1′-biphenyl]-4-yl)-3-hydroxy-1-phenylpropyl]-4-hydroxy-2H-1-benzopyran-2-one or 3-[3-[4-(4-bromophenyl)phenyl]-3-hydroxy-1-phenylpropyl]-2-hydroxychromen-4-one according to the IUPAC nomenclature (IUPAC: International Union of Pure and Applied Chemistry), of the following formula (Chem.6).

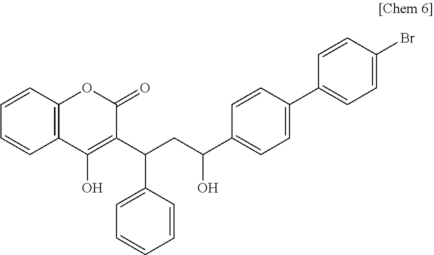 [SMILES: O=c1oc2ccccc2c(O)c1C(CC(O)c1ccc(-c2ccc(Br)cc2)cc1)c1ccccc1]

Bromadiolone extends to the configurational isomers, diastereoisomers and enantiomers of bromadiolone.

In certain embodiments, said composition of AVK(s) comprises—in particular is formed exclusively from—flocoumafen denoting the compound 3-[4-(4-trifluoromethylbenzyloxy)phenyl-4-yl]-1-(4-hydroxycoumarin-3-yl)-1,2,3,4-tetrahydronaphthalene or 4-hydroxy-3-[1,2,3,4-tetrahydro-3-[4-[[4-(trifluoromethyl)phenyl]methoxy]phenyl]-1-naphthalenyl]-2H-1-benzopyran-2-one, or 4-hydroxy-3-[1,2,3,4-tetrahydro-3-[4-(4-trifluoromethylbenzyloxy)phenyl]-1-naphthyl]coumarin according to the IUPAC nomenclature and of the following formula (Chem.7):

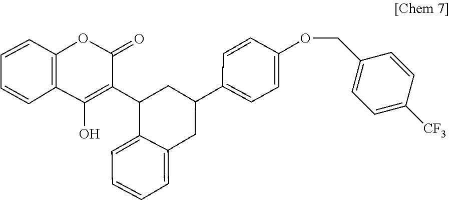 [SMILES: O=c1oc2ccccc2c(O)c1C1CC(c2ccc(OCc3ccc(C(F)(F)F)cc3)cc2)Cc2ccccc21]

Flocoumafen extends to the configurational isomers, diastereoisomers and enantiomers of flocoumafen.

In certain embodiments, said composition of AVK(s) comprises—in particular is formed exclusively from—brodifacoum denoting the compound 3-(4′-bromobiphenyl-4-yl)-1-(4-hydroxycoumarin-3-yl)-1,2,3,4-tetrahydronaphthalene or 4-hydroxy-3-(3-(4′-bromo biphenylyl)-1,2,3,4-tetrahydro-1-naphthyl)coumarin according to the IUPAC nomenclature and of the following formula (Chem.8):

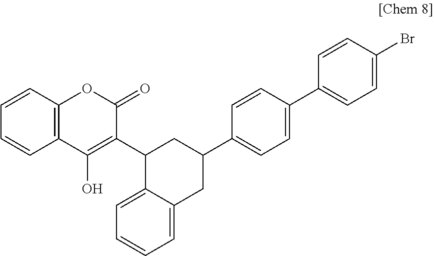 [SMILES: O=c1oc2ccccc2c(O)c1C1CC(c2ccc(-c3ccc(Br)cc3)cc2)Cc2ccccc21]

Brodifacoum extends to the configurational isomers, diastereoisomers and enantiomers of brodifacoum.

In certain embodiments, said composition of AVK(s) comprises—in particular is formed exclusively from—difenacoum denoting 3-(biphenyl-4-yl)-1-(4-hydroxycoumarin-3-yl)-1,2,3,4-tetrahydronaphthalene or 3-(biphenyl-4-yl-1,2,3,4-tetrahydro-1-naphthyl)-4-hydroxycoumarin, or 2-hydroxy-3-[3-(4-phenylphenyl)-1-tetralinyl]-4-chromenone according to the IUPAC nomenclature and of the following formula (Chem.9):

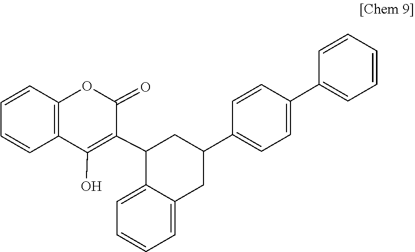 [SMILES: O=c1oc2ccccc2c(O)c1C1CC(c2ccc(-c3ccccc3)cc2)Cc2ccccc21]

Difenacoum extends to the configurational isomers, diastereoisomers and enantiomers of difenacoum.

In certain embodiments, said composition of AVK(s) comprises difethialone denoting 3-(4′bromobiphenyl-4-yl)-1-(4-hydroxythiocoumarin-3-yl)-1,2,3,4-tetrahydronaphthalene or 3-[3-[4-(4-bromophenyl)phenyl]tetralinyl]-2-hydroxy-4-thiochromenone or 3-[3-(4′-bromo[1,1′-biphenyl]-4-yl)-1,2,3,4-tetrahydro-1-naphthalenyl]-4-hydroxy-2H benzothiopyran-2-one according to the IUPAC nomenclature and of the following formula (Chem.10):

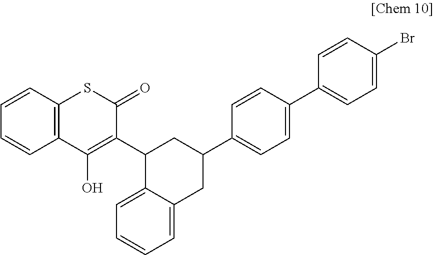 [SMILES: O=c1sc2ccccc2c(O)c1C1CC(c2ccc(-c3ccc(Br)cc3)cc2)Cc2ccccc21]

Difethialone extends to the configurational isomers, diastereoisomers and enantiomers of difethialone.

In certain embodiments, said composition of AVK(s) is formed exclusively from difethialone.

In certain embodiments, said composition of AVK(s) comprises—in particular is formed exclusively from—at least one compound selected from the group comprising chlorophacinone and diphacinone.

In certain embodiments, said vitamin D composition comprises—in particular is formed exclusively from—at least one 9,10-secosteroid compound capable of inducing an increase of tissue calcium.

Throughout the text, the expressions “9,10-secosteroid compound” and “9,10-secosteroid” denote a family of compounds with the following general carbon-containing structure (Chem.11),

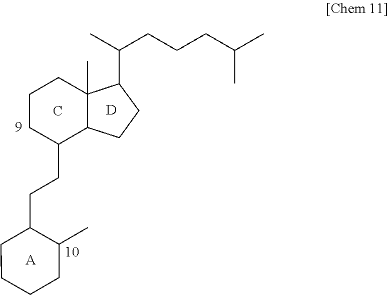

resulting from a steroid compound of general carbon-containing structure (Chem.12) hereunder,

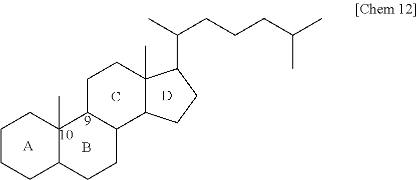

by rupture of the a bond binding carbons 9 and 10 of ring (B) of the steroid compound of general carbon-containing structure (Chem.12), carbons 9 and 10 of the steroid compound of general formula (Chem.11) being bound by a carbon chain of a non-cyclic group.

In certain embodiments, said vitamin D composition comprises—in particular is formed exclusively from—at least one 9,10-secosteroid compound selected from the group comprising cholecalciferol (or vitamin D3) of formula (Chem.13) hereunder,

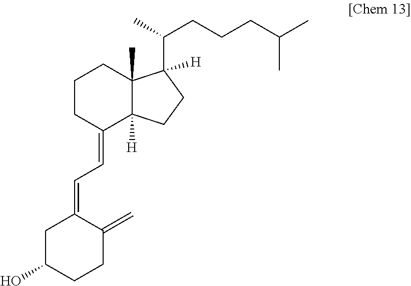 [SMILES: C=C1CC[C@H](O)C/C1=C/C=C1\CCC[C@]2(C)[C@@H]([C@H](C)CCCC(C)C)CC[C@@H]12]

ergocalciferol (or vitamin D2) of formula (Chem.14) hereunder,

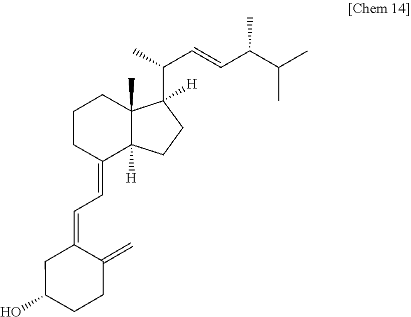 [SMILES: C=C1CC[C@H](O)C/C1=C/C=C1\CCC[C@]2(C)[C@@H]([C@H](C)/C=C/[C@H](C)C(C)C)CC[C@@H]12]

and calcitriol (1,25-dihydroxycholecalciferol or 1,25-dihydroxyvitamin D) of formula (Chem.15) hereunder.

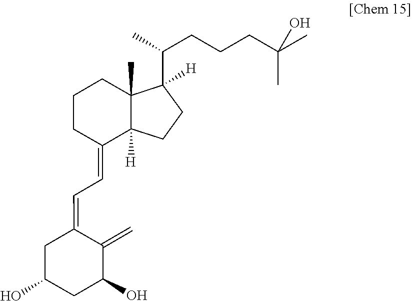 [SMILES: C=C1/C(=C\C=C2/CCC[C@]3(C)[C@@H]([C@H](C)CCCC(C)(C)O)CC[C@@H]23)C[C@@H](O)C[C@@H]1O]

Calcitriol is a metabolite of cholecalciferol having a half-life in the body of the order of 5 hours.

In certain embodiments, the rodenticidal bait according to the invention is formed exclusively from:
at least one compound selected from the group of the 4-hydroxycoumarins substituted in position 3, 4-hydroxythiocoumarins substituted in position 3 and indan-1,3-diones substituted in position 2;
at least one 9,10-secosteroid compound, and
at least one excipient that is edible for target harmful rodents.

In certain embodiments, the rodenticidal bait according to the invention, being formed from said composition of AVK(s), said vitamin D composition and at least one edible excipient that is not rodenticidal for target harmful rodents;
said composition of AVK(s) is formed from difethialone;
said vitamin D composition is formed from cholecalciferol;
the proportion by weight of difethialone in the rodenticidal bait is between 0.70 ppm and +1.20 ppm—in particular between 0.95 ppm and 1.10 ppm, in particular between 0.95 ppm and 1.05 ppm, preferably approximately of the order of 1.00 ppm, inclusive, and in that
the proportion by weight of cholecalciferol in the rodenticidal bait is between 20 ppm and 90 ppm—in particular between 40 ppm and 90 ppm, preferably between 45 ppm and 80 ppm, inclusive. In a particular embodiment, the proportion by weight of cholecalciferol in the rodenticidal bait is approximately of the order of 50 ppm. In another particular embodiment, the proportion by weight of cholecalciferol in the rodenticidal bait is approximately of the order of 75 ppm.

In certain embodiments, the rodenticidal bait according to the invention, being formed from said composition of AVK(s), said vitamin D composition and at least one edible excipient that is not rodenticidal for target harmful rodents;
said composition of AVK(s) is formed from bromadiolone;
said vitamin D composition is formed from cholecalciferol;
the proportion by weight of bromadiolone in the rodenticidal bait is between 1.2 ppm and 1.7 ppm, inclusive, and in that
the proportion by weight of cholecalciferol in the rodenticidal bait is between 20 ppm and 90 ppm—in particular between 40 ppm and 90 ppm, preferably between 45 ppm and 80 ppm, inclusive. In a particular embodiment, the proportion by weight of cholecalciferol in the rodenticidal bait is approximately of the order of 50 ppm. In another particular embodiment, the proportion by weight of cholecalciferol in the rodenticidal bait is approximately of the order of 75 ppm.

According to the invention, the bait is rodenticidal without a significant increase in blood clotting time (Quick's time).

The rodenticidal bait comprises a predominant proportion of at least one excipient that is edible for target harmful rodents. At least one edible excipient is attractive for the target harmful rodents and is able to maintain regular and continuing consumption (for several days) of the rodenticidal bait by these rodents. The edible excipient(s) is(are) selected to allow a daily consumption of rodenticidal bait by a target harmful rodent on average approximately equal to 5% to 15% of its body weight.

At least one edible excipient comprises at least one food selected for stimulating the appetite of the target harmful rodents. Advantageously, the edible excipient comprises at least one palatable food for target harmful rodents.

In certain embodiments, the edible excipient comprises at least one food selected from the group comprising seeds of a cereal or of a plurality of cereals—in particular seeds of a dehulled cereal or of a plurality of dehulled cereals —, milled seeds of a cereal or of a plurality of cereals, flours of seeds of a cereal or of a plurality of cereals, flakes of seeds of a cereal or of a plurality of cereals, bran of seeds of a cereal or of a plurality of cereals and seeds of a non-cereal plant or of seeds of a plurality of non-cereal plants, for example seeds of alfalfa—in particular in dehulled form, in milled form, in the form of flour, in the form of flakes or of bran. There is nothing to prevent the edible excipient comprising, as a mixture, partly or completely seeds of cereals and partly or completely non-cereal seeds. The edible excipient may comprise any substrate consumable by target harmful rodents.

In certain embodiments, the edible excipient comprises or is formed of at least one food selected from the group comprising, partly or completely oat, partly or completely wheat, partly or completely barley, partly or completely maize, partly or completely soya and partly or completely rice.

In certain embodiments, the edible excipient comprises at least one food selected from the group comprising foodstuffs of plant origin and foodstuffs of animal origin.

In certain embodiments, at least one food is selected from the group comprising sweet foodstuffs. It may be a food comprising at least one sugar selected from the group comprising sucrose, lactose, fructose and glucose. It may be a sugar syrup—for example, a sugar syrup obtained by hydrolysis of starch—or a sugar syrup obtained by hydrolysis of sucrose (syrup of invert sugar), or a syrup of beet sugar, or a maple syrup or a syrup from sugar cane, or a syrup obtained from a plant of the genus stevia.

In certain embodiments, at least one food is selected from the group comprising flakes and flour of coconut albumen (copra).

Advantageously, according to certain embodiments, the food is selected from the group comprising walnuts, hazelnuts and almonds. In certain embodiments, the food is in powder form.

In certain embodiments, at least one food is selected from the group comprising vegetable fats, vegetable oils (for example colza oil, soya fat, sunflower oil, cocoa butter, peanut oil, peanut butter, corn oil, palm oil), animal fats and animal oils (butter, lard, fish oil).

In certain embodiments, at least one food is selected from the group comprising proteins of vegetable origin and proteins of animal origin. As an example, we may mention for example milk powder—in particular skimmed milk powder, eggs—in particular egg powder, hydrolysates of proteins of animal origin and hydrolysates of proteins of vegetable origin.

Each edible excipient is not lethal in itself for target harmful rodents. The edible excipient is not rodenticidal in itself.

In certain embodiments, the rodenticidal bait is a solid bait. The rodenticidal bait may be a solid in the divided state, for example in the form of pellets or granules. The rodenticidal bait may be a solid in block form or paste form consumable by the target harmful rodents or a solid material that can be gnawed by the target harmful rodents. In certain embodiments, the solid rodenticidal bait may be in the form of a rigid block, a semirigid block, a mousse, a powder or a gel. In these last-mentioned embodiments, the rodenticidal bait, being in the form of a powder, in the form of a mousse or in the form of a gel, is able to soil the fur of the target harmful rodent(s) and can thus be ingested by the latter during its (their) grooming.

In certain other embodiments, the rodenticidal bait is a liquid bait comprising at least one excipient that is edible for target harmful rodents and is in the liquid state. The rodenticidal bait is then a drink for target harmful rodents.

In certain embodiments, the rodenticidal bait comprises at least one dye.

Said dye makes it possible in particular to give said rodenticidal bait a colour that is easily detectable and identifiable by a person handling the rodenticidal bait.

In certain embodiments, the rodenticidal bait comprises at least one preservative able to ensure its preservation during storage. There is nothing to prevent the rodenticidal bait comprising at least one bittering agent compound of the denatonium benzoate type, also known by the name “Bitrex® ”, intended to reduce the risks of accidental consumption by non-target organisms. Moreover, there is nothing to prevent the rodenticidal bait comprising a non-rodenticidal insecticide and/or acaricide.

The invention also extends to any use of a rodenticidal bait according to the invention for controlling a population of target harmful rodents that are resistant to at least one compound that inhibits vitamin K recycling.

In certain methods of use, at least one compound that inhibits vitamin K recycling is a compound for which at least one strain of target harmful rodents resistant to this compound has been identified. In these methods of use, at least one compound that inhibits vitamin K recycling is a compound in the group comprising warfarin, coumatetralyl, dicoumarol, acenocoumarol, phenprocoumon, 3-(1-(4′-fluorobiphenyl yl)-ethyl)-4-hydroxy-2H-1-benzopyran-2-one of formula (Chem.4), compounds of formula (Chem.5), bromadiolone and difenacoum.

The invention also extends to a method of controlling target harmful rodents.

The invention relates to a method of controlling target harmful rodents, in which a rodenticidal bait according to the invention is disseminated so as to be able to be ingested by the target harmful rodents.

The invention therefore relates to a method of controlling target harmful rodents, in which a rodenticidal bait by ingestion is disseminated so as to be able to be ingested by the target harmful rodents and in a sufficient amount to be lethal for target harmful rodents, the rodenticidal bait by ingestion comprising:
a composition, called composition of AVK(s), of at least one compound that inhibits vitamin K recycling;
a composition, called vitamin D composition, of at least one hypercalcaemia-causing vitamin D, and
at least one excipient that is edible for target harmful rodents; characterized in that:
   said composition of AVK(s) is present in the rodenticidal bait in a proportion by weight, called proportion of AVK(s) by weight, that is not zero and is not lethal on its own for any target harmful rodent, and in that
   said vitamin D composition is present in the rodenticidal bait in a proportion by weight, called the proportion of vitamin D by weight:
      sufficient for said vitamin D composition to be lethal on its own for at least one target harmful rodent, and
      below a minimum proportion by weight sufficient for said vitamin D composition to be lethal on its own for any target harmful rodent.

The method according to the invention makes it possible to control effectively a population of target harmful rodents, while limiting the risks of primary poisoning of non-target animals by reducing the amounts of active substances in the baits. It also makes it possible to control effectively a population of target harmful rodents, while limiting the risks of secondary poisoning of non-target animals.

The invention also relates to a method for selectively controlling a population of target harmful rodents in which a rodenticidal bait by ingestion according to the invention is disseminated:
so as to be able to be ingested by target harmful rodents of the population of target harmful rodents, and
in a sufficient amount to be lethal to females—in particular to adult females—of target harmful rodents consuming this rodenticidal bait, and in which:
said composition of AVK(s) and said vitamin D composition of the rodenticidal bait forming a composition of active substance in a proportion by weight in the rodenticidal bait selected so that the rodenticidal bait is lethal for a (non-zero) proportion, called female mortality, of females of target harmful rodents consuming this rodenticidal bait and to be lethal for a proportion, called male mortality, (possibly zero) of males of target harmful rodents consuming this rodenticidal bait, said female mortality being greater than said male mortality.

In a method for selectively controlling a population of target harmful rodents according to the invention, an amount of rodenticidal bait that can be ingested by the target harmful rodents of the population of target harmful rodents is made available to the target harmful rodents, said amount of rodenticidal bait being sufficient for targeting predominantly the females of target harmful rodents. In a method for selectively controlling a population of target harmful rodents according to the invention, mainly the females—in particular the adult females—of the population of target harmful rodents are targeted, so as to limit the number of litters of target harmful rodents. A method for selectively controlling a population of target harmful rodents according to the invention allows preferential poisoning of the females of target harmful rodents of the population of target harmful rodents leading ultimately to regulation and control of the development of the population of target harmful rodents at the site of selective control.

In a particular embodiment of a method for selective control according to the invention, the proportion of said composition of active substance in the rodenticidal bait and the amount of rodenticidal bait disseminated are adapted so as to kill selectively the females of the population of rodents, without aiming to kill the males of the rodent population.

In a particular embodiment of a method for selectively controlling a population of target harmful rodents, said composition of AVK(s) comprises—in particular is formed from—bromadiolone in a proportion by weight of 1 ppm and cholecalciferol in a proportion by weight of 75 ppm.

In this embodiment, the population of target harmful rodents comprises homozygotic Sprague-Dawley rats that have undergone introgression for the L120Q mutation of the Vkorc1 gene coding for subunit 1 of the vitamin K epoxide reductase complex (“Vitamin K epOxide Reductase Complex (VKORC) subunit 1”).

In this embodiment, the population of target harmful rodents comprises house mice (Mus musculus) homozygotic for the L128S mutation of the Vkorc1 gene coding for subunit 1 of the vitamin K epoxide reductase complex.

In this embodiment, the population of target harmful rodents comprises mice (Mus spretus) homozygotic for a plurality of mutations of the Vkorc1 gene coding for subunit 1 of the vitamin K epoxide reductase complex.

The invention also relates to a rodenticidal bait, the use thereof and a method of controlling target harmful rodents, characterized, whether or not in combination, by some or all of the features mentioned above or hereunder. Regardless of the formal presentation thereof, unless stated otherwise explicitly, the various features mentioned above or hereunder must not be considered to be closely or inextricably linked together; the invention may relate to only one of these structural or functional features, or only some of these structural or functional features, or only a part of one of these structural or functional features, or else to any group, combination or juxtaposition of some or all of these structural or functional features.

Other aims, features and advantages of the invention will become clearer on reading the following description and the non-limiting examples given to illustrate certain embodiments, and which relate to the appended figures in which:

FIG. 1 is a graphical representation illustrating the synergistic effect of a treatment of rodents by gavage with a composition according to the invention combining bromadiolone and cholecalciferol (filled triangle, ▴) on warfarin-sensitive rodents, compared to treatment with bromadiolone alone (filled diamond, ♦) or cholecalciferol alone (filled circle, ●) at the same dose;

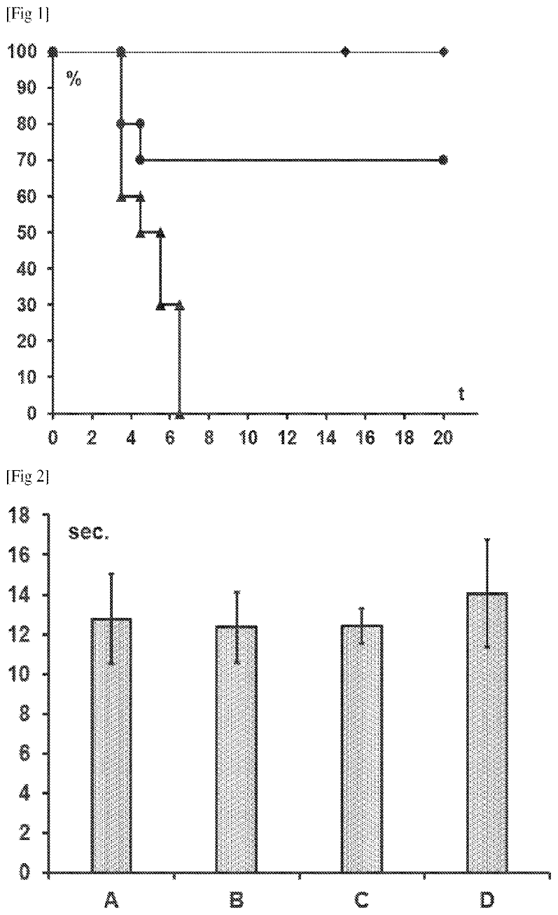

FIG. 2 is a graphical representation illustrating the blood clotting time (Quick's time) of warfarin-sensitive rodents treated with a composition according to the invention combining bromadiolone and cholecalciferol, or treated with bromadiolone alone or treated with cholecalciferol alone as illustrated in [FIG. 1] compared to untreated rodents;

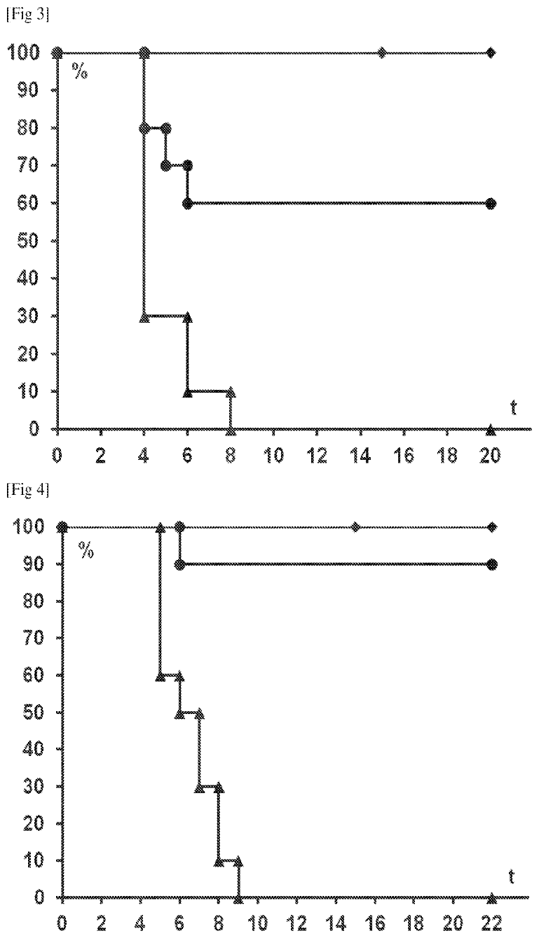

FIG. 3 is a graphical representation illustrating the synergistic effect of treatment with a composition according to the invention combining difethialone and cholecalciferol (filled triangle, ▴) on warfarin-sensitive rodents, compared to treatment with difethialone alone (filled diamond, ♦) or cholecalciferol alone (filled circle, ●) at the same dose, and

FIG. 4 is a graphical representation illustrating the synergistic effect of treatment with a composition according to the invention combining difethialone and cholecalciferol (filled triangle, ▴) on warfarin-resistant rodents, compared to treatment with difethialone alone (filled diamond, ♦) or cholecalciferol alone (filled circle, ●) at the same dose.

A rodenticidal bait by ingestion according to the invention comprises at least one excipient that is edible for target harmful rodents, a composition, called composition of AVK(s), of at least one compound that inhibits vitamin K recycling and a composition, called vitamin D composition, of at least one hypercalcaemia-causing vitamin D. Said composition of AVK(s) is present in the rodenticidal bait according to the invention with a proportion by weight, called proportion of AVK(s), selected so that said composition of AVK(s) is not rodenticidal on its own for each target harmful rodent of the population of rodents whose control is desired. Furthermore, said composition of AVK(s) is not anticoagulating. Said vitamin D composition is present in the rodenticidal bait according to the invention with a proportion by weight, called proportion of vitamin D, selected so that said vitamin D composition is not lethal at 100% on its own. Quite surprisingly and unforeseeably, a rodenticidal bait by ingestion according to the invention is effective on any population of target harmful rodents, in particular on any population of warfarin-sensitive target harmful rodents and on a majority of target harmful rodents resistant to at least one anticoagulant of the antivitamin K type, and in particular resistant to warfarin. The surprising rodenticidal efficacy of a rodenticidal bait by ingestion according to the invention seems to be based on a synergistic effect provided by the combination of said vitamin D composition and said composition of AVK(s), the synergistic effect provided being distinct from an anticoagulant effect. Accordingly, a rodenticidal bait by ingestion according to the invention reduces the risk of secondary poisoning of non-target animals.

Bromadiolone

Synergy of Bromadiolone and Cholecalciferol

A group of 10 warfarin-sensitive male OFA-Sprague-Dawley rats (Charles River, L′Arbresles, France), aged 10 weeks and with a body weight between 160 and 180 g, are fed by gavage for 5 consecutive days with a gavage solution containing bromadiolone (LIPHATECH, France) and cholecalciferol (Sigma-Aldrich, France) in a solvent consisting of 95% (v/v) of oil and 5% (v/v) of DMSO. During this period of gavage, the rats are fed with a conventional solid feed and water in unlimited amounts. The rats are fed by gavage with a volume of this gavage solution so as to administer an amount of bromadiolone corresponding to 0.1 mg of bromadiolone per kilogram of body weight of the rat fed by gavage and an amount of cholecalciferol corresponding to 7.5 mg of cholecalciferol per kilogram of body weight of the rat fed by gavage. The rats in two control groups, each consisting of 10 male OFA-Sprague-Dawley rats, are fed by gavage in the same conditions with gavage solutions containing, respectively, bromadiolone alone so as to administer an amount of bromadiolone corresponding to 0.1 mg of bromadiolone per kilogram of body weight of the rat fed by gavage and cholecalciferol alone so as to administer an amount of cholecalciferol corresponding to 7.5 mg of cholecalciferol per kilogram of body weight of the rat fed by gavage. The percentage of rats surviving gavage is noted daily for 20 days counting from the first day of gavage (D0). The results presented [FIG. 1] show the variation of the percentage of rodents surviving (in %) as a function of time (t, in days) following the first day of gavage. The rats fed by gavage with bromadiolone solution (filled diamond, ♦) have 100% survival after 20 days of observation. The rats fed by gavage with the cholecalciferol solution (filled circle, ●) have 70% survival after 20 days of observation. Quite surprisingly and unforeseeably, none of the rats fed by gavage with the solution of bromadiolone combined with cholecalciferol (filled triangle, ▴) survives for 20 days of observation. The mortality in the group of rats fed by gavage with the solution of bromadiolone combined with cholecalciferol is 100% starting from 7 days after the start of gavage.

Prothrombin Level—Quick's Time

Warfarin-sensitive male OFA-Sprague-Dawley rats (Charles River, L′Arbresles, France) are fed by gavage for 3 consecutive days with a gavage solution containing bromadiolone (LIPHATECH, France) and cholecalciferol (Sigma-Aldrich, France) in a solvent consisting of 95% (v/v) of oil and 5% (v/v) of DMSO. During this period of gavage, the rats are fed with a conventional solid feed and water in unlimited amounts. The concentrations of bromadiolone and cholecalciferol in the gavage solution are 0.1 g/kg (100 ppm) and 7.5 g/kg (7500 ppm) respectively. Each rat receives daily a volume of gavage solution calculated to correspond to 1 mL of gavage solution per kilogram of body weight. The OFA-Sprague-Dawley rats in two control groups are fed by gavage in the same conditions with gavage solutions containing bromadiolone (alone) at a concentration of 100 ppm or cholecalciferol (alone) at a concentration of 7500 ppm, respectively. 24 hours after the last gavage, a volume of blood is taken from each rat by intracardiac puncture and placed in a specimen tube containing sodium citrate. The animals are euthanized after puncture and the plasma is prepared by centrifugation. Quick's time (or clotting time) is evaluated on the plasma supplemented with sodium citrate, then decalcified and recalcified in the presence of calcium thromboplastin. Quick's time is evaluated by means of an optical device for clotting analysis (Option 2plus, Bio Mèrieux®). The results are presented [FIG. 2]. The average Quick's time measured on the plasma from the rats fed by gavage with bromadiolone (bar “B”) is 12.4 seconds (±1.8), the average Quick's time measured on the plasma from the rats fed by gavage with cholecalciferol (bar “C”) is 12.4 seconds (±0.9) and the average Quick's time measured on the plasma from the rats fed by gavage with the composition comprising bromadiolone and cholecalciferol (bar “D”) is 14.1 seconds (±2.7). The differences in values of Quick's time measured between the three groups of rats are not significant. The rats in the group of rats that received the combination of bromadiolone and cholecalciferol coagulate in the same way as the rats in the group of rats that received the gavage solution containing bromadiolone on the one hand and the rats in the group of rats that received the gavage solution containing cholecalciferol on the other hand. Quick's time for rats treated with a control solution formed from oil (95%, v/v) and DMSO (5%, v/v) is (bar “A”) 12.8 seconds (±2.3). Neither the gavage solution containing bromadiolone in combination with cholecalciferol, nor the gavage solution containing bromadiolone alone, nor the gavage solution containing cholecalciferol induces an increase of Quick's time relative to the control. They are not anticoagulants. The gavage solution containing bromadiolone and cholecalciferol in combination according to the invention is a rodenticide and is not an anticoagulant.

Rodenticidal Bait by Ingestion According to the Invention Tested on L120Q Sprague-Dawley Rats that have Undergone Introgression

L120Q Sprague-Dawley (“SD”) rats (10 male rats and 10 female rats) that have undergone introgression, which are homozygotic carriers of the L120Q mutation in the Vkorc1 gene, are acclimatized for 5 days in individual cages in the presence of a conventional solid feed and water in unlimited amounts. At D0, the conventional solid feed is removed and replaced with a rodenticidal bait by ingestion according to the invention in a sufficient amount to satisfy the rodents' appetite and without any other choice of consumption (“no choice”) than the rodenticidal bait alone. The rodenticidal bait by ingestion according to the invention is made available for 5 days, and then is replaced with a conventional solid feed. The rodenticidal bait by ingestion according to the invention is made up of flour of cereals, fat, starch, a red dye and an oily solvent as edible excipient, bromadiolone in a proportion by weight of 0.9 ppm and cholecalciferol in a proportion by weight of 75 ppm. The duration of monitoring is 21 days counting from the first day of presentation of the baits (D0). The rats stop feeding after 3 days of consumption of the rodenticidal bait. The mortality and the average delay before death of the animal are given in Table 1 hereunder for the male rats and for the female rats.

TABLE 1

“SD” having undergone introgression L120Q

| | Mortality, % | Delay (days) |
|---|---|---|
| Male | 66 | 6.5 |
| Female | 100 | 4.5 |

The average mortality (males and females) of the L120Q “SD” rats that had undergone introgression is of the order of 83%. The rodenticidal bait by ingestion according to the invention is more effective on these female rats than on these male rats. In any case, no haemorrhagic sign is observed in these rats (males and females) that had consumed the rodenticidal bait by ingestion according to the invention.

Rodenticidal Bait by Ingestion According to the Invention Tested on House Mice (“Mus musculus”) Bearing the L128S Mutation

A test carried out in similar conditions to the test carried out with L120Q “SD” rats that had undergone introgression described above is carried out with male and female house mice (Mus musculus) that are homozygotic carriers of the L128S mutation in the Vkorc1 gene. The rodenticidal bait by ingestion according to the invention is made up of flour of cereals, fat, starch, a red dye and an oily solvent as edible excipient, bromadiolone in a proportion by weight of 1 ppm and cholecalciferol in a proportion by weight of 75 ppm. The duration of monitoring is 21 days counting from the first day of presentation of the baits (D0). The mice stop feeding after 3 days of consumption of the rodenticidal bait. The mortality and the average delay before death of the animal are given in Table 2 hereunder.

TABLE 2

| L128S mice | Mortality, % | Delay (days) |
|---|---|---|
| Male | 30 | 9.5 |
| Female | 70 | 5.5 |

The rodenticidal bait by ingestion according to the invention is more effective on the female house mice bearing the L128S mutation than on the male mice bearing the L128S mutation. In any case, no haemorrhagic sign is observed in the house mice bearing the L128S mutation (males and females) that consumed the rodenticidal bait by ingestion according to the invention.

Rodenticidal Bait by Ingestion According to the Invention on “Spretus” House Mice Bearing the Vkorc1 Gene

A test carried out in similar conditions to the test carried out with L120Q “SD” rats that had undergone introgression, described above, is carried out with “Spretus” house mice bearing the Vkorc1 gene. The rodenticidal bait by ingestion according to the invention is made up of flour of cereals, fat, starch, a red dye and an oily solvent as edible excipient, bromadiolone in a proportion by weight of 1 ppm and cholecalciferol in a proportion by weight of 75 ppm. The duration of monitoring is 21 days counting from the first day of presentation of the baits (D0). The mice stop feeding after 3 days of consumption of the rodenticidal bait. The mortality and the average delay before death of the animal are given in Table 3 hereunder.

TABLE 3

| “Spretus” mice | Mortality, % | Delay (days) |
|---|---|---|
| Male | 10 | 7 |
| Female | 30 | 10 |

The rodenticidal bait by ingestion according to the invention is more effective on the female “Spretus” mice than on the male “Spretus” mice. In any case, no haemorrhagic sign is observed in the male and female “Spretus” mice that consumed the rodenticidal bait by ingestion according to the invention.

Relative Toxicity of Cholecalciferol in Male Rodents and Female Rodents

Warfarin-sensitive Sprague-Dawley rats (20 male rats and 20 female rats), male and female rats that are homozygotic carriers of the L120Q mutation, male and female Sprague-Dawley rats that are homozygotic carriers of the Y139F mutation and male and female brown rats (Rattus norvegicus) that are homozygotic carriers of the Y1 39C mutation are acclimatized for 5 days in the presence of a conventional solid feed and water in unlimited amounts. The rats are fed by gavage with a single dose of a gavage solution containing cholecalciferol (Sigma-Aldrich, France) in a solvent consisting of 95% (v/v) of oil and 5% (v/v) of DMSO. The rats are fed with a conventional solid feed and water in unlimited amounts. The amount of cholecalciferol administered is 30 mg of cholecalciferol per kilogram of body weight of the rat fed by gavage. The percentage of rats surviving gavage for 20 days, counting from the first day of gavage, is noted daily. The results given in Table 4 hereunder describe the mortality observed (“SD”, Sprague-Dawley). The amount of cholecalciferol ingested by the rodents during gavage corresponds to consumption by these rodents of a bait assayed at 300 ppm of cholecalciferol.

TABLE 4

| Rodents | Male mortality, % | Female mortality, % |
|---|---|---|
| “SD” | 10 | 30 |
| L120Q | 15 | 5 |
| Y139F | 30 | 0 |
| Y139C | 30 | 0 |

The use of cholecalciferol 300 ppm for controlling warfarin-resistant target harmful rodents leads to selection of the female warfarin-resistant rodents whereas the use of a rodenticidal bait by ingestion according to the invention allows on the contrary (Table [1], Table [2] and Table [3]) selective control directed preferentially at female warfarin-resistant target harmful rodents. This results in a decrease in the number of litters of target harmful rodents and improved efficacy of control.

Difethialone

Absence of Rodenticidal Effect of a Control Bait Comprising Difethialone 1 ppm on OFA-Sprague-Dawley Rats

In a rodenticidal bait by ingestion according to the invention, said composition of AVK(s) (in this test, difethialone) is present in the rodenticidal bait in a proportion by weight, called proportion of AVK(s) by weight, that is not zero (1 ppm) and is not lethal on its own for any target harmful rodent consuming a bait, called bait of AVK(s) (difethialone bait), formed from said at least one excipient and said composition of AVK(s) (difethialone)—alone as active substance in said bait of AVK(s)—and in said proportion of AVK(s) (1 ppm) in said bait of AVK(s). Warfarin-sensitive OFA-Sprague-Dawley white rats (5 male and 5 female) are put in individual cages and are acclimatized for 3 days in these cages and fed with a conventional solid feed and water in unlimited amounts. At D0, the conventional solid feed is replaced with a ration of bait, called difethialone bait, comprising difethialone in a proportion by weight of 1 ppm (1 mg of difethialone per kilogram of bait). The ration of difethialone bait supplied is 50 grams per rat. At D1, D2 and D3, the amount of difethialone bait consumed by each rat is measured and then the ration of difethialone bait is made up to 50 grams. Each animal is weighed at D0, D1, D2, D3 and D4. The average consumption of difethialone bait is given in Table 5 hereunder. The rats are kept under surveillance and are fed starting from D4 with a conventional solid feed and water in unlimited amounts until D21. No refusal of food is observed. 100% of the rats survive to D21. None of the rats presents a haemorrhagic sign. Said difethialone bait at 1 ppm is not rodenticidal for OFA-Sprague-Dawley rats consuming this bait for 3 days.

TABLE 5

| | Average consumption, |
|---|---|
| | g/kg of rat's weight |
| D 1 | 62.8 |
| D 2 | 71.3 |
| D 3 | 60.3 |
| D 4 | 61.6 |

Synergy of Difethialone and Cholecalciferol on Warfarin-Sensitive Rats

A group of warfarin-sensitive male OFA-Sprague-Dawley rats (Charles River, L′Arbresles, France), aged 10 weeks and with a body weight between 160 and 180 g, are fed by gavage once a day for 3 consecutive days with a gavage solution containing difethialone (LIPHATECH, France) and cholecalciferol (Sigma-Aldrich, France) in a solvent consisting of 95% (v/v) of oil and 5% (v/v) of DMSO. During this period of gavage, the rats are fed with a conventional solid feed and water in unlimited amounts. The amounts of difethialone and cholecalciferol administered are 125 μg per kilogram of body weight of the rat fed by gavage and 7.5 mg per kilogram of body weight of the rat fed by gavage, respectively. The rats in two control groups, each consisting of OFA-Sprague-Dawley rats, are fed by gavage in the same conditions with gavage solutions containing difethialone alone (125 μg/kg) or cholecalciferol alone (7.5 mg/kg), respectively. The percentage of rats surviving gavage is recorded daily, for 20 days counting from the first day of gavage. The results presented [FIG. 3] show the variation of the percentage of rodents surviving (in %) as a function of time (t, in days) following the first day of gavage. The rats fed by gavage with the difethialone solution (♦) have 100% survival after 20 days of observation. The rats fed by gavage with the cholecalciferol solution (●) show 60% survival after 2 days of observation. Quite surprisingly and unforeseeably, none of the rats fed by gavage with the solution of difethialone combined with cholecalciferol (▴) survives for 20 days of observation. The mortality in the group of rats fed by gavage with the solution of difethialone combined with cholecalciferol is 100% starting from 8 days after the start of gavage. The synergistic effect has been demonstrated.

Dose/Rodenticidal Response Effect of Difethialone on Warfarin-Sensitive Rats

A gavage solution containing difethialone (LIPHATECH, France) in a solvent consisting of 95% (v/v) of oil and 5% (v/v) of DMSO is administered once a day for 3 consecutive days to warfarin-sensitive male OFA-Sprague-Dawley rats (Charles River, L′Arbresles, France), aged 10 weeks and with a body weight between 160 and 180 g. During this period of gavage, the rats are fed with a conventional solid feed and water in unlimited amounts. The doses of difethialone administered to the OFA-Sprague-Dawley rats, given in Table 6 hereunder, are expressed in micrograms of difethialone administered per kilogram of body weight of the gavage-fed rodent.

TABLE 6

| Difethialone dose, μg/kg | Mortality, % |
|---|---|
| 0 | 0 |
| 50 | 0 |
| 100 | 0 |
| 150 | 40 |
| 200 | 100 |
| 500 | 100 |

The percentage of rats surviving gavage is recorded daily for 21 days counting from the first day of gavage.

Prothrombin Level—Quick's Time

Nine warfarin-sensitive male OFA-Sprague-Dawley rats (Charles River, L′Arbresles, France) are fed by gavage for 3 consecutive days with difethialone (LIPHATECH, France) in solution in a mixture consisting of 90% (v/v) of oil and 10% (v/v) of DMSO. The concentration of difethialone in the gavage solution is 0.1 g/kg (100 ppm). Each rat receives daily a volume of gavage solution calculated to correspond to 1 mL of gavage solution per kilogram of its body weight (i.e. 1 ppm). 24 hours after the last gavage, a volume of blood is taken from each rat by intracardiac puncture and placed in a specimen tube containing sodium citrate. The animals are euthanized after puncture and the plasma is prepared by centrifugation. No haemorrhagic sign is observed in the rats fed by gavage with the difethialone solution. Quick's time (or clotting time) is evaluated on the plasma supplemented with sodium citrate, then decalcified and recalcified in the presence of calcium thromboplastin. Quick's time is evaluated by means of an optical device for clotting analysis (Option 2plus, Bio Mèrieux®). The average Quick's time measured on the plasma from the rats fed by gavage with difethialone is 23.4 seconds (±6.1). For comparison, the average Quick's time of control rats fed by gavage with the solution without difethialone is 17.5 seconds (±2.1). The difference in values of Quick's time of the rats fed by gavage with the difethialone solution and with the control solution without difethialone is not significant. The value of Quick's time of the rats fed by gavage with the difethialone solution, not significantly increased relative to the Quick's time of the rats in the control group, is representative of a normal coagulation situation, the blood of the rats that had received the gavage solution comprising difethialone clotting comparably to the blood of the control rats. The gavage solution containing difethialone alone does not induce an increase in Quick's time relative to the control and is not anticoagulating.

Dose/Rodenticidal Response Effect of Cholecalciferol

A gavage solution containing cholecalciferol (Sigma-Aldrich, France) in a solvent consisting of 95% (v/v) of oil and 5% (v/v) of DMSO is administered once a day for 3 consecutive days to warfarin-sensitive male OFA-Sprague-Dawley rats (Charles River, L′Arbresles, France), aged 10 weeks and with a body weight between 160 and 180 g. During this period of gavage, the rats are fed with a conventional solid feed and water in unlimited amounts. The doses of cholecalciferol administered to the OFA-Sprague-Dawley rats, given in Table 7 hereunder, are expressed in milligrams of cholecalciferol administered per kilogram of body weight of the gavage-fed rodent.

TABLE 7

| Cholecalciferol dose, mg/kg | Mortality, % |
|---|---|
| 0 | 0 |
| 5 | 20 |
| 7.5 | 30 |

The percentage of rats surviving gavage is noted daily for 21 days counting from the first day of gavage.

Synergy of Difethialone and Cholecalciferol on Warfarin-Resistant Female Sprague-Dawley Y139F Rats

Female Sprague-Dawley rats that are homozygotic carriers of the Y139F mutation in the Vkorc1 gene, aged 10 weeks, are acclimatized for 5 days in the presence of a conventional solid feed and water in unlimited amounts. These female Sprague-Dawley Y139F rats are fed by gavage once a day for 3 consecutive days with a gavage solution containing difethialone (LIPHATECH, France) and cholecalciferol (Sigma-Aldrich, France) in a solvent consisting of 95% (v/v) of oil and 5% (v/v) of DMSO. During this period of gavage, the rats are fed with a conventional solid feed and water in unlimited amounts. The amounts of difethialone and cholecalciferol administered are 0.125 mg per kilogram of body weight of the rat fed by gavage and 7.5 mg per kilogram of body weight of the rat fed by gavage, respectively. The rats in two control groups, each consisting of OFA-Sprague-Dawley Y137F rats, are fed by gavage in the same conditions with gavage solutions containing, respectively, difethialone alone so as to administer an amount of difethialone corresponding to 0.125 mg per kilogram of body weight of the rat fed by gavage and cholecalciferol alone so as to administer an amount of cholecalciferol corresponding to 7.5 mg per kilogram of body weight of the rat fed by gavage. The percentage of rats surviving gavage is noted daily for 21 days counting from the first day of gavage. The results presented [FIG. 4] show the variation of the percentage of rodents surviving (in %) as a function of time (t, in days) following the first day of gavage. The rats fed by gavage with the difethialone solution (♦) have 100% survival after 22 days of observation. The rats fed by gavage with the cholecalciferol solution (●) show 90% survival after 22 days of observation. Quite surprisingly and unforeseeably, none of the rats fed by gavage with the solution of difethialone combined with cholecalciferol (▴) survives to 22 days of observation. The mortality in the group of rats fed by gavage with the solution of difethialone combined with cholecalciferol is 100% starting from 9 days after the start of gavage. The synergistic effect has been demonstrated.

Synergy of Difethialone and Cholecalciferol on Male and Female Sprague-Dawley Rats, L120Q, Y139F and Y139C

Warfarin-sensitive male and female Sprague-Dawley rats, male and female rats that are homozygotic carriers of the L120Q mutation, male and female Sprague-Dawley rats that are homozygotic carriers of the Y139F mutation and male and female brown rats (Rattus norvegicus) that are homozygotic carriers of the Y139C mutation are acclimatized for 5 days in the presence of a conventional solid feed and water in unlimited amounts. The rats are fed by gavage once a day for 3 consecutive days with a gavage solution containing difethialone (LIPHATECH, France) and cholecalciferol (Sigma-Aldrich, France) in a solvent consisting of 95% (v/v) of oil and 5% (v/v) of DMSO. During this period of gavage, the rats are fed with a conventional solid feed and water in unlimited amounts. The amounts of difethialone and cholecalciferol administered are 0.125 mg per kilogram of body weight of the rat fed by gavage and 7.5 mg per kilogram of body weight of the rat fed by gavage, respectively. The percentage of rats surviving gavage is noted daily for 21 days counting from the first day of gavage. The results given in Table 8 describe the mortality and the mean time to occurrence (“MTO”) of this mortality (“SD”, Sprague-Dawley).

TABLE 8

| | Male | MTO, | Female | |
|---|---|---|---|---|
| Line | Mortality, % | days | Mortality, % | MTO |
| “SD” | 100 | 6.8 | n.d. | n.d. |
| L120Q | 100 | 5.3 | 100 | 5.1 |
| Y139F | 100 | 6.1 | 100 | 5.5 |
| Y139C | 100 | 5.4 | 100 | 6.7 |

Dose/Rodenticidal Response Effect of Difethialone on Warfarin-Resistant Male Y139F Rats

A gavage solution containing difethialone (LIPHATECH, France) in a solvent consisting of 95% (v/v) of oil and 5% (v/v) of DMSO is administered once a day for 3 consecutive days to male Sprague-Dawley rats that have undergone introgression, which are homozygotic carriers of the Y139F mutation in the Vkorc1 gene. During this period of gavage, the rats are fed with a conventional solid feed and water in unlimited amounts. The doses of difethialone administered to the Sprague-Dawley rats that have undergone introgression, given in Table 9 hereunder, are expressed in micrograms of difethialone administered per kilogram of body weight of the gavage-fed rodent.

TABLE 9

| Difethialone dose, μg/kg | Mortality, % |
|---|---|
| 0 | 0 |
| 100 | 0 |
| 125 | 0 |
| 250 | 100 |
| 500 | 100 |

The percentage of rats surviving gavage is noted daily for 21 days counting from the first day of gavage. 100% of the Sprague-Dawley rats that had undergone introgression survive gavage for 3 days with 0.125 mg of difethialone per kilogram of body weight per day.

The invention may be the subject of many variants and applications other than those described above. In particular, it goes without saying that unless stated otherwise, the various structural and functional features of each of the embodiments described above are not to be regarded as combined and/or closely and/or inextricably linked together, but on the contrary as simple juxtapositions. Furthermore, the structural and/or functional features of the different embodiments described above may be the subject wholly or partly of any different juxtaposition or of any different combination.

1. A rodenticidial bait by ingestion for at least one target harmful rodent ingesting this bait for an ingestion period, called consumption time, imposed owing to said ingestion; the rodenticidal bait comprising:
a composition, called composition of AVK(s), of at least one compound that inhibits vitamin K recycling;
a composition, called vitamin D composition, of at least one hypercalcaemia-causing vitamin D, and
at least one excipient that is edible for target harmful rodents;
wherein:
said composition of AVK(s) is present in the rodenticidal bait in a proportion by weight, called proportion of AVK(s) by weight, that is not zero and is not lethal on its own for any target harmful rodent ingesting this bait for said consumption time, and in that
said vitamin D composition is present in the rodenticidal bait in a proportion by weight, called the proportion of vitamin D by weight:
sufficient for said vitamin D composition to be lethal on its own for at least one target harmful rodent, and
below a minimum proportion by weight sufficient for said vitamin D composition to be lethal on its own for any target harmful rodent.

2. The bait according to claim 1, wherein said composition of AVK comprises at least one compound selected from the group comprising 4-hydroxycoumarins substituted in position 3, 4-hydroxythiocoumarins substituted in position 3 and indan-1,3-diones substituted in position 2.

3. The bait according to claim 1, wherein said composition of AVK(s) comprises at least one 4-hydroxycoumarin substituted in position 3 selected from the group comprising coumachlor, warfarin, coumatetralyl, dicoumarol, acenocoumarol, phenprocoumon, 3-(1-(4′-fluorobiphenyl yl)-ethyl)-4-hydroxy-2H-1-benzopyran-2-one, of formula (Chem.4) hereunder, 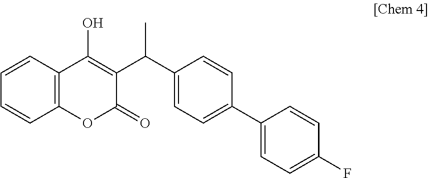 [SMILES: CC(c1ccc(-c2ccc(F)cc2)cc1)c1c(O)c2ccccc2oc1=O]
compounds of formula (Chem.5) hereunder, 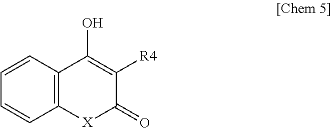
in which X is an atom selected from the group comprising oxygen (O) and sulphur (S) and R4 is a hydrocarbon-containing group selected from the group comprising a 3-phytyl group and linear hydrocarbon chains having from 8 to 18 carbon atoms;
bromadiolone, brodifacoum, flocoumafen, difenacoum and difethialone.

4. The bait according to claim 1, wherein said composition of AVK(s) comprises difethialone.

5. The bait according to claim 4, wherein said composition of AVK(s) is formed exclusively from difethialone.

6. The bait according to claim 1, wherein said vitamin D composition comprises at least one 9,10-secosteroid compound capable of inducing an increase of tissue calcium.

7. The bait according to claim 1, wherein said vitamin D composition comprises at least one compound selected from the group comprising cholecalciferol, ergocalciferol and calcitriol.

8. The bait according to claim 1, it wherein said bait is formed from said composition of AVK(s), said vitamin D composition and at least one edible excipient that is not rodenticidal for target harmful rodents, and in that:
said composition of AVK(s) is formed from difethialone;
said vitamin D composition is formed from cholecalciferol;
the proportion by weight of difethialone in the rodenticidal bait is between 0.70 ppm and 1.20 ppm, inclusive, and in that
the proportion by weight of cholecalciferol in the rodenticidal bait is between 20 ppm and 90 ppm, inclusive.

9. The bait according to claim 1, wherein:
said composition of AVK(s) is formed from bromadiolone;
said vitamin D composition is formed from cholecalciferol;
the proportion by weight of bromadiolone in the rodenticidal bait is between 1.2 ppm and 1.7 ppm, inclusive, and in that
the proportion by weight of cholecalciferol in the rodenticidal bait is between 20 ppm and 90 ppm, inclusive.

10. The bait according to claim 1, it wherein said bait is rodenticidal without a significant increase in blood clotting time.

11. A method for controlling a population of target harmful rodents that are resistant to at least one compound that inhibits vitamin K recycling, said method comprising the steps of:
Applying a rodenticidal bait according to claim 1.

12. The method according to claim 11, wherein at least one compound that inhibits vitamin K recycling is a compound in the group comprising warfarin, coumatetralyl, dicoumarol, acenocoumarol, phenprocoumon, 3-(1-(4′-fluorobiphenyl-4-yl)-ethyl)-4-hydroxy-2H-1-benzopyran-2-one of formula (Chem.4) hereunder, 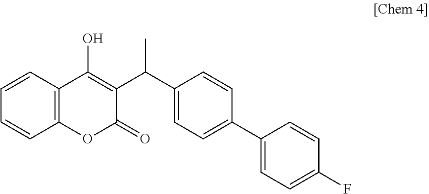 [SMILES: CC(c1ccc(-c2ccc(F)cc2)cc1)c1c(O)c2ccccc2oc1=O]
compounds of formula (Chem.5) hereunder, 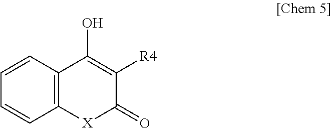
in which X is an atom selected from the group comprising oxygen (O) and sulphur (S) and R4 is a hydrocarbon-containing group selected from the group comprising a 3-phytyl group and linear hydrocarbon chains having from 8 to 18 carbon atoms,
bromadiolone and difenacoum.

13. A method of controlling target harmful rodents in which a rodenticidal bait by ingestion is disseminated;
so as to be able to be ingested by target harmful rodents for a period, called the consumption time, imposed owing to said ingestion, and
in a sufficient amount to be lethal for target harmful rodents;
the rodenticidal bait by ingestion comprising:
a composition, called composition of AVK(s), of at least one compound that inhibits vitamin K recycling;
a composition, called vitamin D composition, of at least one hypercalcaemia-causing vitamin D, and
at least one excipient that is edible for target harmful rodents;
wherein:
said composition of AVK(s) is present in the rodenticidal bait in a proportion by weight, called proportion of AVK(s) by weight, that is not zero and is not lethal on its own for any target harmful rodent, and in that
said vitamin D composition is present in the rodenticidal bait in a proportion by weight, called the proportion of vitamin D by weight:
sufficient for said vitamin D composition to be lethal on its own for at least one target harmful rodent, and
below a minimum proportion by weight sufficient for said vitamin D composition to be lethal on its own for any target harmful rodent.

14. The method according to claim 13, wherein the method is a method for selectively controlling a population of target harmful rodents in which the rodenticidal bait by ingestion is disseminated:
so as to be able to be ingested by target harmful rodents of the population of target harmful rodents, and
in a sufficient amount to be lethal for females of target harmful rodents consuming this rodenticidal bait, and in which;
said composition of AVK(s) and said vitamin D composition of the rodenticidal bait forming a composition of active substance in proportion by weight in the rodenticidal bait selected so that the rodenticidal bait is lethal for a proportion, called female mortality, of females of target harmful rodents consuming this rodenticidal bait and to be lethal for a proportion, called male mortality, of males of target harmful rodents consuming this rodenticidal bait, said female mortality being greater than said male mortality.
